(19) United States
(12) Patent Application Publication
(10) Pub. No.: US 2009/0195104 A1
(43) Pub. Date: Aug. 6, 2009

(54) PERMANENT MAGNET SYNCHRONOUS MOTOR

(75) Inventors: Satoru AKUTSU, Chiyoda-ku (JP); Kazuhisa Takashima, Chiyoda-ku (JP); Yoshihito Asao, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Tokyo (JP)

(21) Appl. No.: 12/139,991

(22) Filed: Jun. 16, 2008

(30) Foreign Application Priority Data
Jan. 18, 2008 (JP) 2008-009358

(51) Int. Cl. H02K 21/14; H02K 21/16; B62D 5/04

(52) U.S. Cl. 310/156.38; 180/443

(57) ABSTRACT

To obtain a permanent magnet synchronous motor suitable for an electric power steering system, in which the magnet thickness (magnet used amount) can be reduced while securing demagnetization resistance and torque characteristics. In a permanent magnet synchronous motor including a rotor in which plural permanent magnets are arranged at an outer periphery of a rotor core, which is supported so as to rotate freely, and a stator provided at the outside of the stator and having stator windings 5 and a stator core, when a gap length between the outer periphery of the permanent magnet and an internal periphery of the stator core is “L” [mm] and the thickness of the central portion of the permanent magnet in the motor rotation direction is “t” [mm], the gap length “L” and the thickness “t” is set in a range of

L≦1 [mm] as well as t/(t+L)≦0.9

### BACKGROUND OF THE INVENTION

1. Field of the Invention

The invention relates to a permanent magnet synchronous motor which is used for an electric power steering system and the like.

2. Background Art

In Patent Document 1, an example of a 10-pole 12-slot permanent magnet synchronous motor for an electric power steering system is shown, which includes a rotor having a rotor core to which plural permanent magnets are provided at an outer periphery, supported so as to rotate freely and a stator having stator windings and a stator core, provided at the outside of the rotor through a gap, and the contents in which the whole split-core type stator are resin-molded after winding, then, cutting operation is performed to an internal circle are disclosed.

Patent Document 1: JP-A-2005-348522

The conventional permanent magnet synchronous motor for the electric power steering system as described above takes a large gap length “L” [mm], therefore, there are problems that a thickness “t” [mm] of a magnet for securing demagnetization resistance and torque characteristics becomes large, that the magnet used amount increases and that costs of the motor increase.

Additionally, since split cores are used, it is difficult to secure circularity of the internal circle of the core and it is necessary to cut the internal circle to decrease cogging torque. Accordingly, there are problems that costs of the motor becomes high because man-hour of the process increases, that overcurrent loss increases because an interlayer insulation of the internal circle portion of the laminated core is broken and a short circuit occurs between layers of the laminated core, and that demagnetization resistance of the magnet deteriorates because the temperature rise of the motor increases due to heat generation.

### SUMMARY OF THE INVENTION

The invention has been made in order to solve the above problems and an object thereof is to provide a permanent magnet synchronous motor in which the thickness of magnets can be small while securing demagnetization resistance and torque characteristics.

In a permanent magnet synchronous motor including a rotor having a rotor core in which plural permanent magnets are provided at an outer periphery, supported so as to rotate freely and a stator having stator windings and a stator core, provided at the outside of the rotor through a gap, when a gap length between the outer periphery of the permanent magnet and an inner periphery of the stator core is “L” [mm] and a thickness of the central portion of the permanent magnet in the motor rotation direction is “t” [mm], the gap length “L” and the thickness “t” are set in a range of

L≦1 [mm] as well as t/(t+L)≦0.9.

The foregoing and other object, features, aspects and advantages of the present invention will become more apparent from the following detailed description of the present invention when taken in conjunction with accompanying drawings.

### ADVANTAGE OF THE INVENTION

According to the invention, a permanent magnet synchronous motor suitable for an electric power steering system and the like, in which the thickness of magnets can be small while securing demagnetization resistance and torque characteristics.

### BRIEF DESCRIPTION OF THE DRAWINGS

FIG. 1 is a cross-sectional view in an axial direction of a permanent magnet synchronous motor according to Embodiment 1 of the invention;

FIG. 2A and FIG. 2B are a plan view and a side view of the permanent magnet synchronous motor according to Embodiment 1 of the invention;

FIG. 3 is a partial cross-sectional view showing the relation between a gap length “L” of the motor and a thickness “t” of a central portion of the permanent magnet in the embodiment 1;

FIG. 4 is a graph showing the relation among the gap length “L”, t/(t+L) and the demagnetization factor in the embodiment 1;

FIG. 5 is a graph showing the relation among the gap length “L”, t/(t+L) and the torque in the embodiment 1;

FIG. 6 is a cross-sectional view of a 5n-pole 6n-slot motor according to Embodiment 2;

FIG. 7 is a cross-sectional view of a 7n-pole 6n-slot motor according to Embodiment 2;

FIG. 8 is a table showing the relation among the number of poles, the number of slots and winding factors in the embodiment 2;

FIG. 9 is a cross-sectional view of a permanent magnet synchronous motor according to Embodiment 3;

FIG. 10 is a development elevation of a stator core of the permanent magnet synchronous motor according to the Embodiment 3;

FIG. 11A to FIG. 11D show cross-sectional views of a stator core showing a rotation lamination state of the stator core of a permanent magnet synchronous motor according to Embodiment 4;

FIG. 12 is a cross-sectional view of a permanent magnet synchronous motor according to Embodiment 5;

FIG. 13 is a development elevation of a stator core of the permanent magnet synchronous motor according to Embodiment 5;

FIG. 14 is a partial cross-sectional view showing the relation between a thickness “t” of the central portion of a magnet and a thickness “e” of both-end portions of the magnet of a motor according to Embodiment 6;

FIG. 15 is a graph showing the relation between a ratio “e/t” which is the ratio of the thickness “t” of the central portion of the magnet and the thickness “e” of the both-end portions of the magnet and the demagnetization factor in Embodiment 6;

FIG. 16 is a graph showing the relation between a ratio “e/t” which is the ratio of the thickness “t” of the central portion of the magnet and the thickness “e” of the both-end portions of the magnet and the cogging torque in Embodiment 6;

FIG. 17 is a graph showing the relation between remanent flux density Br [T] of the permanent magnet and the demagnetization factor of a motor according to Embodiment 7; and

FIG. 18 is an outline view of an electric power steering system.

### DESCRIPTION OF THE PREFERRED EMBODIMENT

### Embodiment 1

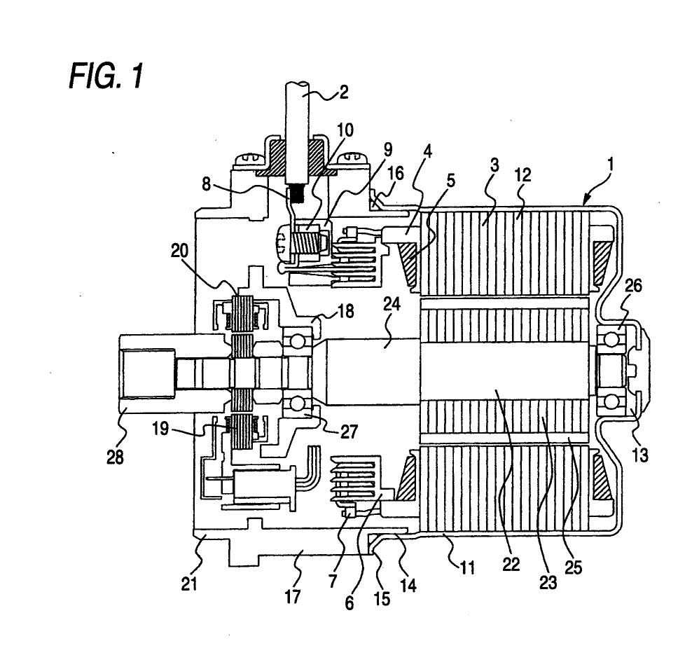

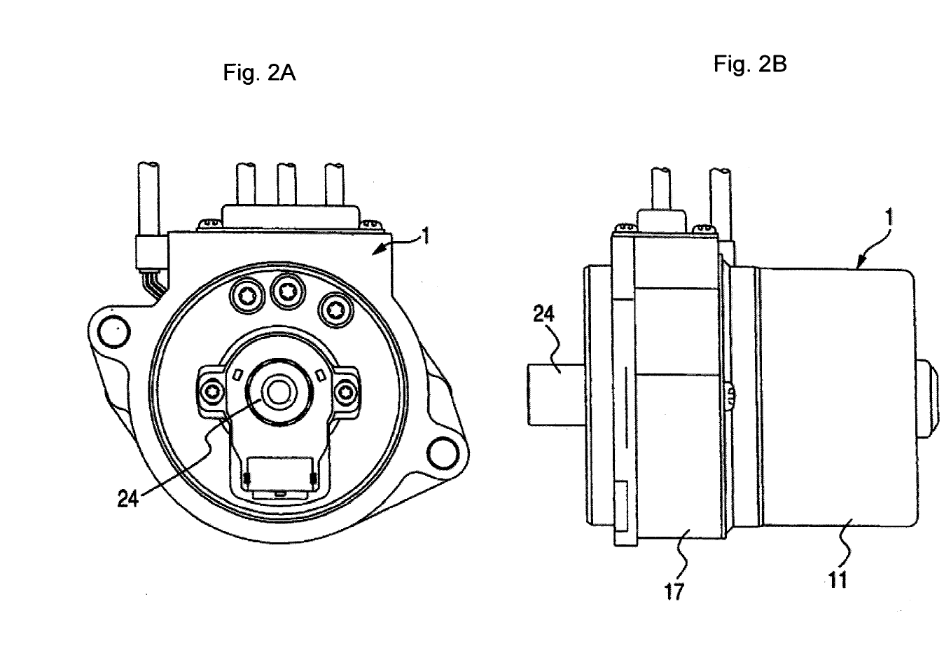

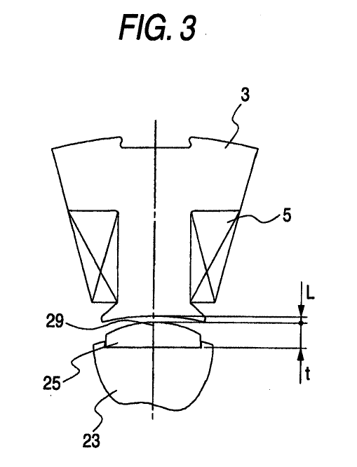

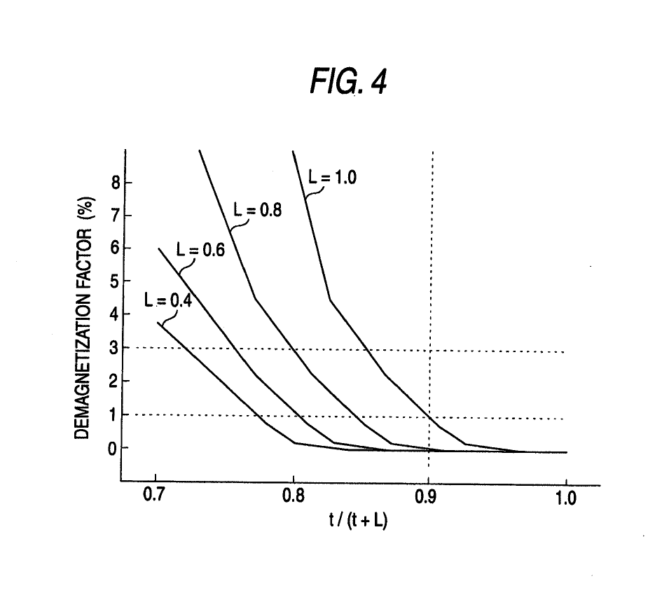

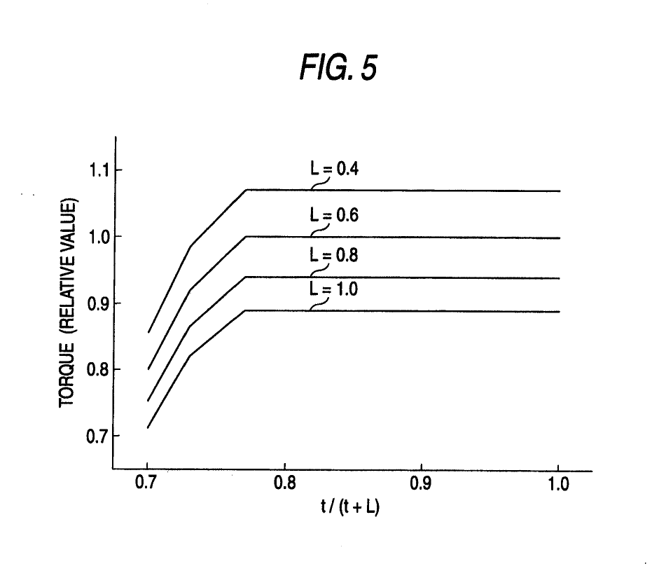

FIG. 1 is a cross-sectional view in an axial direction of a permanent magnet synchronous motor according to Embodiment 1 of the invention, FIG. 2A and FIG. 2B are a plan view and a side view of the permanent magnet synchronous motor, FIG. 3 is a partial cross-sectional view showing the relation between a gap length “L” of the motor and a thickness “t” of a central portion of the permanent magnet in the embodiment 1, FIG. 4 is a graph showing the relation among the gap length “L”, t/(t+L) and the demagnetization factor, and FIG. 5 is a graph showing the relation among the gap length “L”, t/(t+L) and the torque.

In FIG. 1, a permanent magnet synchronous motor (hereinafter, simply referred to as a motor) 1 includes a rotor 22 having a rotor core 23 in which plural permanent magnets 25 are arranged at an outer periphery thereof, supported so as to rotate freely and a stator 12 having stator windings 5 and a stator core 3, provided at the outside of the rotor through a gap.

The stator core 3 is formed by laminating electromagnetic steel sheets, and three-phase stator windings 5 are wound therearound through an insulator 4 made of resin. The windings 5 of respective phases are Δ-connected by winding terminals 7 housed in terminal holders 6 made of resin, and connection terminals 8 for connecting to lead wires 2 are attached to the winding terminals 7 of respective phases. The connection terminals 8 are attached to connection terminal base portions 9 and nuts 10 for attaching the lead wires 2 to the connection terminals 8 are housed inside the connection terminal base portions 9.

The stator core 3 is pressed into a frame 11 made of steel, which forms the stator 12 of the motor 1. One end of the frame 11 has a bottom portion and a rear bearing box portion 13 housing a rear bearing 26 for supporting one end of the rotor 22 is formed at the central portion of the bottom portion. The other end of the frame 11 opens and a socket-and-spigot portion 14 for connecting to a housing 17 of the motor 1 is formed. At an outer periphery of the socket-and-spigot portion 14 of the frame 11, a flange portion 15 including a screwing portion for screwing the stator 12 in the housing 17 of the motor 1 is formed. A frame grommet 16 having an o-ring shape for preventing water is provided between the housing 17 and the flange portion 15 of the stator 12 of the motor 1.

The housing 17 of the motor 1 is formed by a die-cast molding of an aluminum alloy and a front bearing box 18 housing a front bearing 27 for supporting one end of the rotor 22 is formed at the central portion. In the vicinity of the front bearing box 18 of the housing 17, a resolver mounting portion 20 for mounting a resolver 19 which is a rotation sensor for detecting a rotation angle of the rotor 22 is formed. At an end portion of the housing 17 which is opposite to the side to which the stator 12 is mounted, a mounting socket-and-spigot portion 21 for mounting the motor 1 to other equipment is provided.

The rotor 22 has a configuration in which plural NdFe rare-earth segment permanent magnets each having a semicircular shape in cross section are mounted at an outer periphery of the rotor core 23 which is formed by laminating electromagnetic steel sheets, which is mounted to a shaft 24 made of steel, and both ends of the shaft 24 are supported so as to rotate freely by the rear bearing 26 and the front bearing 27. At an end of the front side of the shaft 24, a boss 28 as a coupling for coupling with other equipment.

The above is a basic configuration of the motor 1. According to Embodiment 1 of the invention, in the above motor 1, when a gap length between the outer periphery of the permanent magnet 25 and an inner periphery of the stator core 3 is “L” [mm], and a thickness of a central portion 29 (hereinafter, referred to as a magnet central portion) of the permanent magnet 25 in a rotation direction of the motor is “t” [mm], the gap length “L” and the thickness “t” of the magnet central portion 29 are set so as to satisfy the relation of the following.

L≦1 [mm], as well as t/(t+L)≦0.9

Specifically, “L” is set within a range of 0.6 to 0.7 [mm], and t/(t+L) is set within a range of 0.77 to 0.85. When t/(t+L) is made small, the thickness “t” of the magnetic central portion 29, namely, the magnet thickness becomes small and the magnet used amount degreases, however, the demagnetization factor at the time of operating the motor shown in FIG. 4 increases, which deteriorates demagnetization resistance. Further, the torque shown in FIG. 5 decrease and it becomes difficult to secure motor characteristics. Accordingly, it is necessary to prescribe the range of the gap length “L” in addition to t/(t+L). The securement of the demagnetization resistance and decrease of the magnet used amount can be simultaneously achieved by prescribing them.

This is because the demagnetization factor decreases as shown in FIG. 4, and the torque increases as shown in FIG. 5 when the gap length “L” is made small. As a target of necessary demagnetization resistance, the demagnetization factor is preferably 3% in a level of actual use, more preferably, 1%.

Therefore, according to Embodiment 1, the magnet thickness, namely, the magnet used amount can be decreased while securing the demagnetization resistance and torque characteristics, thereby obtaining the motor suitable for the electric power steering system and the like.

### Embodiment 2

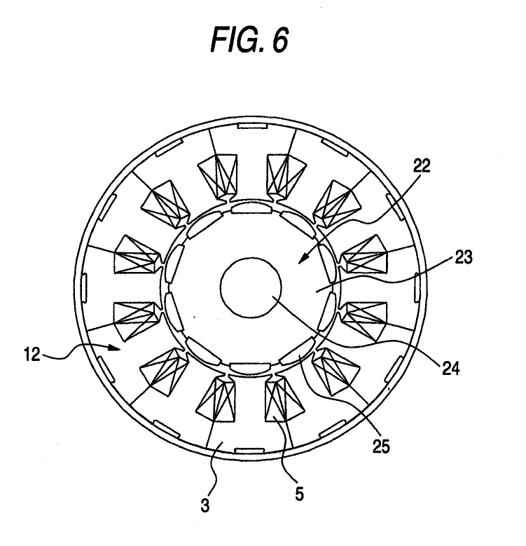

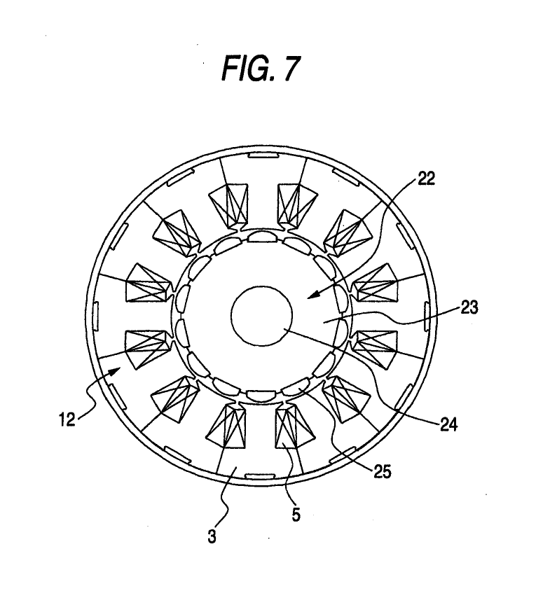

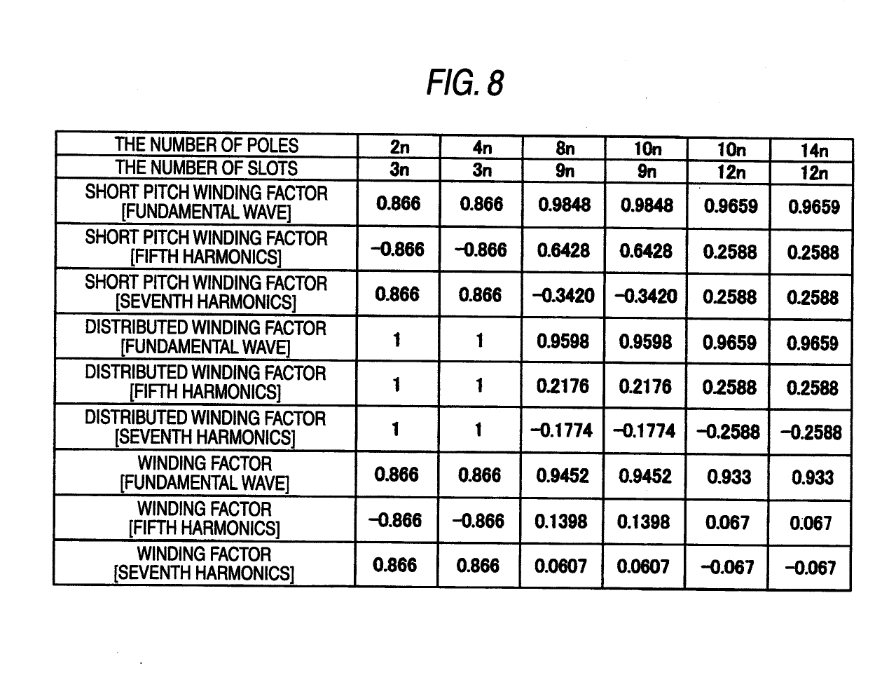

FIG. 6 is a cross-sectional view of a 5n-pole 6n-slot motor according to Embodiment 2 of the invention, FIG. 7 is a cross-sectional view of a 7n-pole 6n-slot motor also according to Embodiment 2, and FIG. 8 is a table showing the relation among the number of poles, the number of slots and winding factors.

The motor according to Embodiment 2 is set in a state that, when the number of poles of the permanent magnets 25 is “P” and the number of slots of the stator 12 is “N” in the motor shown in Embodiment 1, the number of poles “P” and the number of slots “N” will be

P:N=5n:6n, or 7n:6n (“n” is an integer of 2 or more), as shown in FIG. 6 or FIG. 7.

This is for reducing the magnet thickness (magnet used amount) while securing demagnetization resistance and torque characteristics by selecting combinations of the number of poles and the number of slots having the higher winding factors shown in FIG. 8, because the higher the winding factor is, the larger the torque is, even in the case of the same magnet amount.

The combination of the number of poles and the number of slots is selected to be 5n:6n or 7n:6n because the winding factor with respect to the fundamental wave is large and the winding factor with respect to the higher harmonics is small. The combinations 8n:9n, 10n:9n have large winding factors to the fundamental wave, however, the winding factors with respect to the higher harmonics are also large, therefore, it is not preferable because skew and the like are necessary to decrease torque ripple, as a result, the torque decreases.

In the combination of 5n:6n or 7n:6n, when the combination in which the number of poles is minimum, which is the case of 5n:6n with n=2, namely, the 10-poles 12-slots type is selected, it is possible to alleviate the increase of overcurrent loss due to multi-poles and deterioration of demagnetization resistance due to rise of temperature by heat generation.

According to the Embodiment 2, the combination of the number of poles and slots which has higher winding factors is selected, thereby obtaining advantages that the magnet thickness (magnet used amount) can be decreased while securing the demagnetization resistance and torque characteristics.

### Embodiment 3

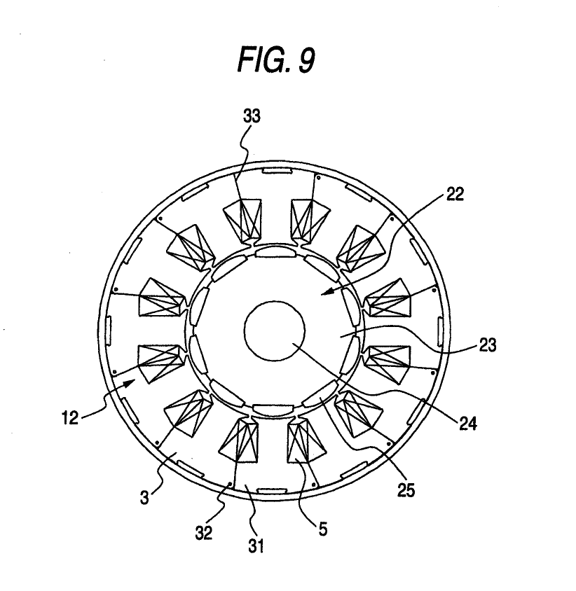

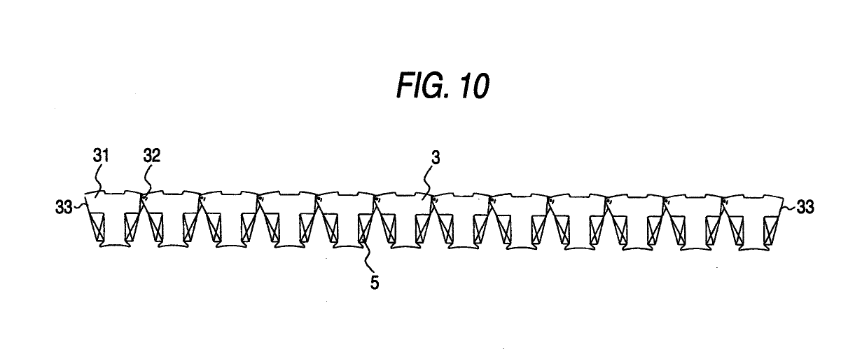

FIG. 9 is a cross-sectional view of a motor according to Embodiment 3 of the invention and FIG. 10 is a development elevation of a stator core of the motor according to the Embodiment 3.

In the motor according to the Embodiment 3, as shown in FIG. 9 and FIG. 10, the stator core 3 has a configuration in which laminated steel sheets overlap one another at contact portions of split cores 31 as well as sheets are coupled by circular projections 32 provided at overlapped portions to be rotated one another in the motor shown in Embodiment 1.

The stator core 3 has a circular shape when punched from a steel plate and comes out after being laminated in a mold. The laminated core is developed by being rotated at portions coupled by the circular projections 32 to perform winding. After that, the stator core is obtained by making a circle again with the projections 33.

According to the above configuration, the winding becomes easy as well as it is easy to secure the circularity of an internal circle of the stator core 3 as compared with the conventional split cores disclosed in Patent Document 1 because the core is originally punched in a circle, therefore, cutting operation of the internal circle of the core becomes unnecessary.

### Embodiment 4

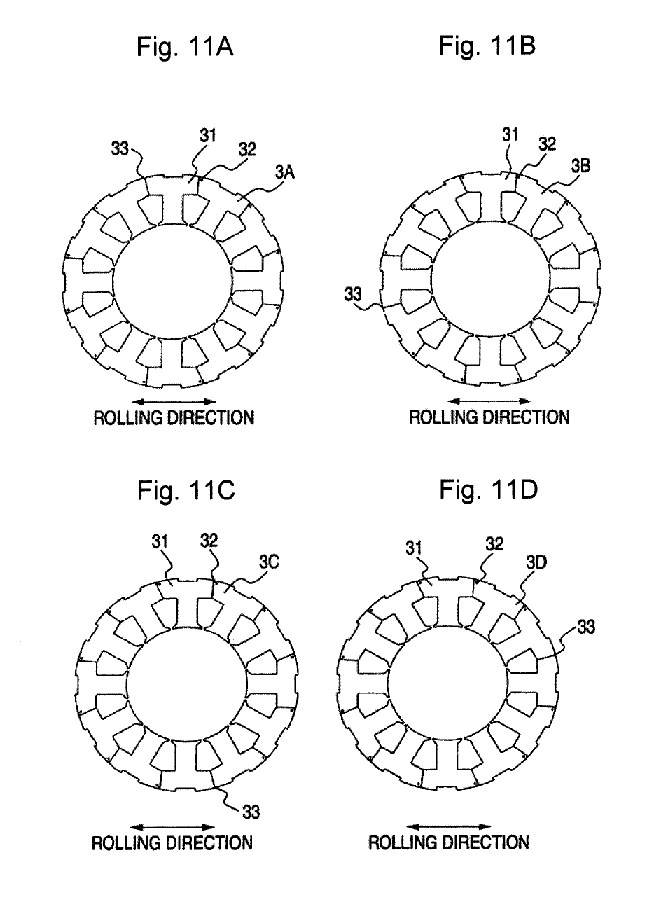

FIG. 11A to FIG. 11D are cross-sectional views of stator cores showing a state of rotation lamination of the stator cores of a motor according to Embodiment 4 of the invention.

The motor according to Embodiment 4 is formed by appropriately combining 4 kinds of cores 3A to 3D processed in the rolling direction as shown in FIG. 11 and laminating them in the motor shown in Embodiment 1. At that time, the cores are laminated by rotating the cores so that butt portions 33 the respective cores are in the same position.

Accordingly, the core can be developed by rotating coupling portions of the circular projections 32 even in the case of the core which is formed by rotation lamination. It is possible to prevent lamination slant due to thickness deviation of steel material and impairment of the circularity of the internal circle of the core by performing rotation lamination, and the circularity of the internal circle of the stator core 3 can be secured, therefore, cutting operation of the internal circle of the core becomes unnecessary.

### Embodiment 5

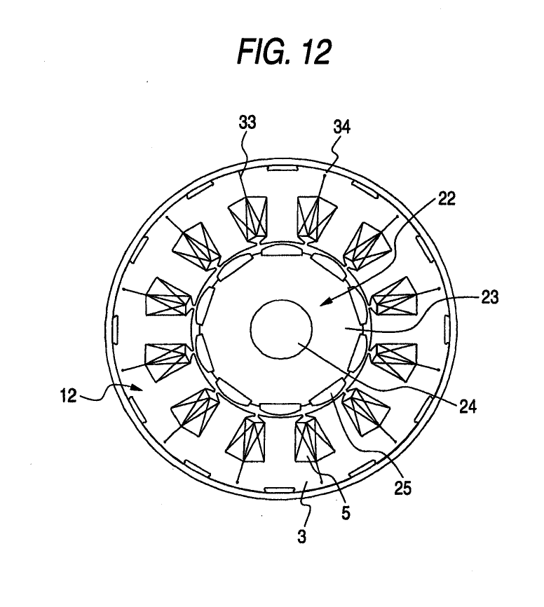

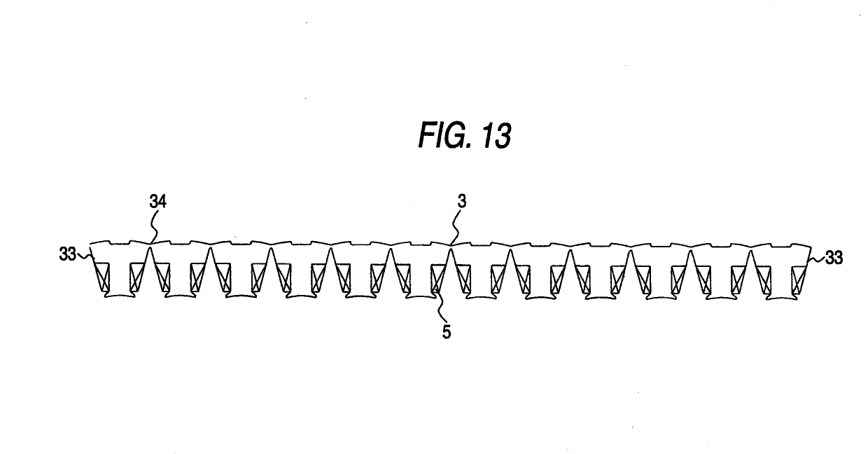

FIG. 12 is a cross-sectional view of a motor according to Embodiment 5 of the invention and FIG. 13 is a development elevation of a stator core of the motor according to Embodiment 5.

As shown in FIG. 12 and FIG. 13, the motor according to the Embodiment 5 has a stator core 3 as a coupled core, in which plural core portions are coupled in a belt shape by coupling portions 34 in the motor shown in Embodiment 1. The stator core 3 is in a state of being coupled in a linear line when punched from the steel plate and comes out after being laminated in a mold. The winding is performed to the laminated core in the state being coupled in the linear line, after that, a stator core can be obtained by making the whole core in a circular shape by folding the coupling portions 34.

According to the above configuration, the winding becomes easy as well as the securement of circularity of the internal circle of the core is easy as compared with the conventional split cores shown in Patent Document 1, as a result, cutting operation of the internal circle of the core becomes unnecessary.

### Embodiment 6

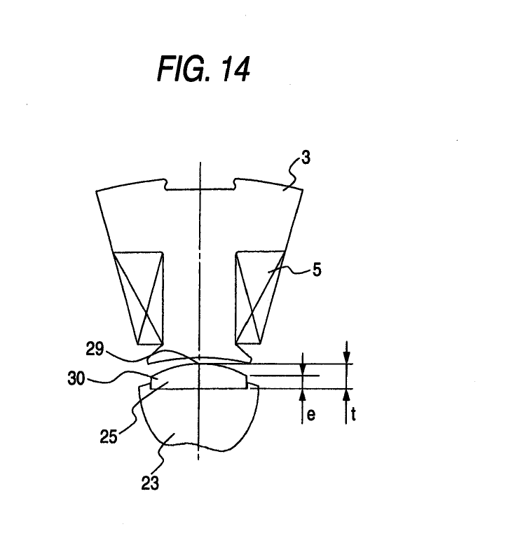

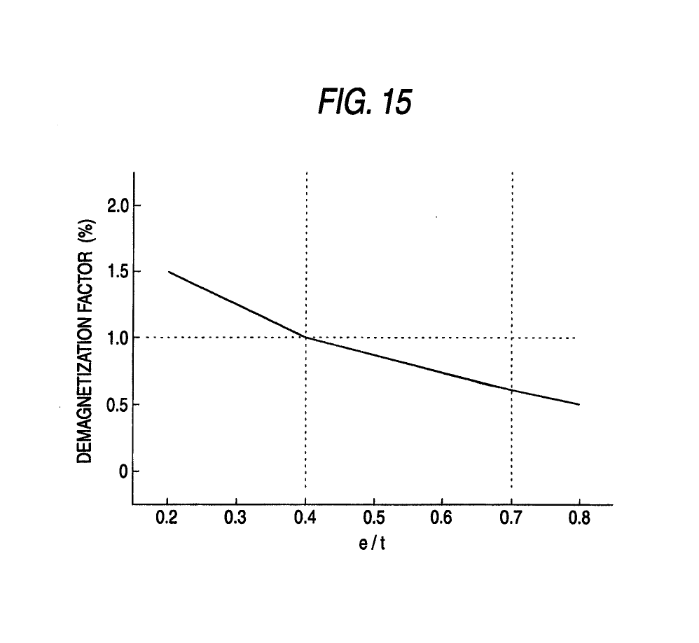

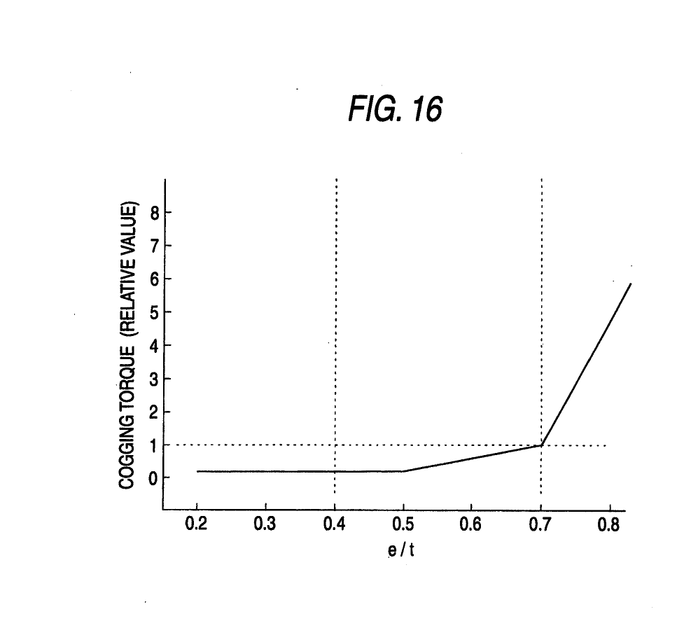

FIG. 14 is a partial cross-sectional view showing the relation between a thickness “t” of the central portion of a magnet and a thickness “e” of both-end portions of the magnet of a motor according to Embodiment 6 of the invention, FIG. 15 is a graph showing the relation between a ratio “e/t” which is the ratio of the thickness “t” of the central portion of the magnet and the thickness “e” of the both-end portions of the magnet and the demagnetization factor, and FIG. 16 is a graph showing the relation between the ratio “e/t” which is the ratio of the thickness “t” of the central portion of the magnet and the thickness “e” of the both-end portions of the magnet and cogging torque.

The motor according to the Embodiment 6 has a configuration in which the NdFe rare-earth segment permanent magnet is used for the permanent magnet 25 in the motor shown in Embodiment 1, and when the thickness of a central portion of a magnet 29 is “t” [mm] and the thickness of the both-end portions of the magnet 30 is “e” [mm], the thickness “t” of the central portion of the magnet 29 and the thickness “e” of the both-end portions of the magnet 30 will be

0.4≦e/t≦0.7.

When the ratio “e/t” between the thickness “e” of the both-end portions of the magnet 30 and the thickness “t” of the central portion of the magnet 29 is smaller, the used amount of the permanent magnet 25 is smaller, which is advantageous in costs, however, the demagnetization factor increases and the demagnetization resistance deteriorates as shown in FIG. 15.

Conversely, when “e/t” is smaller, cogging torque decreases as shown in FIG. 16, which will be advantageous in motor characteristics. The range of setting “e/t” is the range which is effective for both cogging torque and demagnetization resistance, in which motor characteristics can be secured while decreasing magnet used amount. Here, the upper limit setting value of “e/t” is in the vicinity of a value at which the cogging torque suddenly increases.

### Embodiment 7

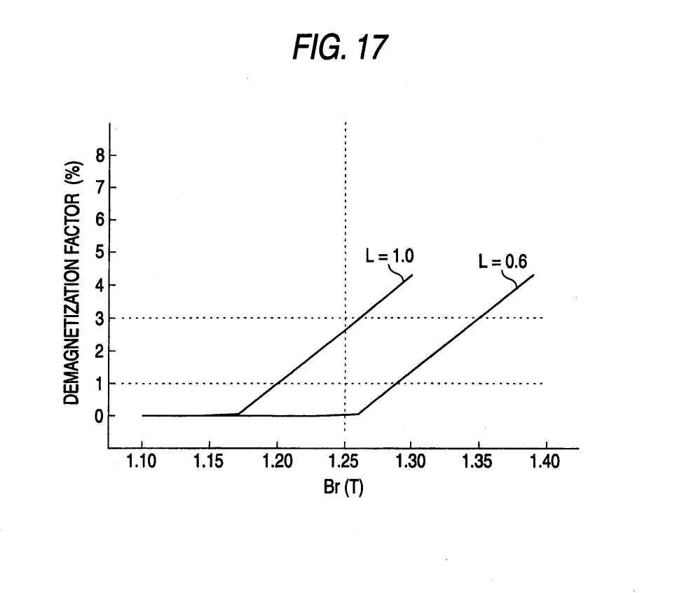

FIG. 17 is a graph showing the relation between remanent flux density Br [T] of the permanent magnet 25 and the demagnetization factor of a motor according to Embodiment 7 of the invention.

The motor according to the Embodiment 7 has a configuration in which the NdFe rare-earth segment permanent magnet is used for the permanent magnet 25 in the motor shown in Embodiment 1, and is set so that the remanent flux density Br of the permanent magnet 25 will be

Br≧1.2 [T]

As characteristics of the permanent magnet 25, the greater the remanent flux density Br becomes, the smaller iHc becomes, which is disadvantageous for the demagnetization resistance. Conversely, in order to obtain the same torque, it is preferable to use the permanent magnet having the large remanent flux density Br because the magnet thickness will be small, that is, the magnet used amount can be decreased. Concerning the relation between the gap length “L” and the demagnetization factor, the demagnetization factor is small when the gap length is small as described above.

Therefore, it is possible to decrease the magnet amount while securing the demagnetization resistance by prescribing the relation between the gap length L≦1 [mm] and the remanent flux density Br.

As shown in FIG. 17, the demagnetization factor can be 3% or less, or 1% or less by selecting respective values appropriately within the range of L≦1, Br≧1.2.

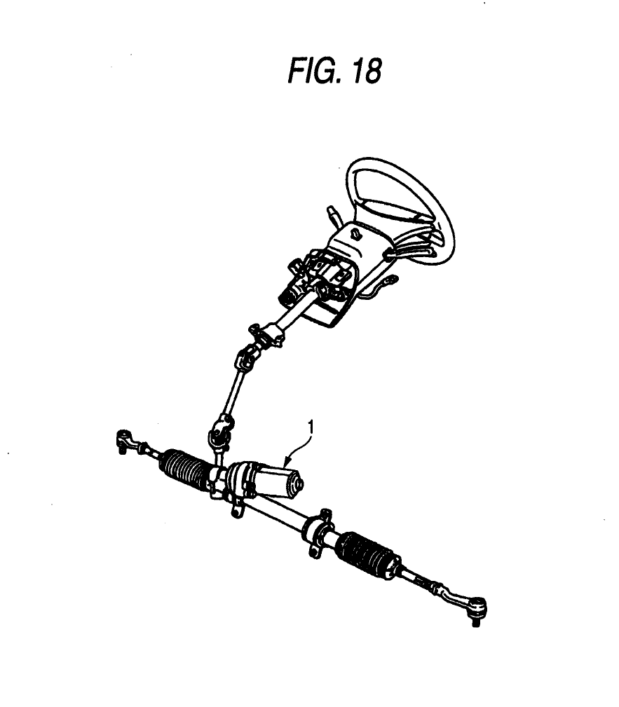

The motor 1 according to the above Embodiments 1 to 7 can be applied as a motor for an electric power steering system as shown in FIG. 18, and low-cost by the decrease of magnet used amount, improvement of steering feeling by the decrease of cogging torque and securement of applicability to vehicles by improvement of demagnetization resistance can be achieved.

Various modifications and alternations of this invention will be apparent to those skilled in the art without departing from the scope and spirit of this invention, and it should be understood that this is not limited to the illustrative embodiments set forth herein.

What is claimed is:

1. A permanent magnet synchronous motor, comprising:
a rotor having a rotor core in which plural permanent magnets are provided at an outer periphery, supported so as to rotate freely; and
a stator having stator windings and a stator core, provided at the outside of the rotor through a gap, and
wherein, when a gap length between the outer periphery of the permanent magnet and an inner periphery of the stator core is “L” [mm] an a thickness of the central portion of the permanent magnet in the motor rotation direction is “t” [mm], the gap length “L” and the thickness “t” are set in a range of
L≦1 [mm] as well as t/(t+L)≦0.9.

2. The permanent magnet synchronous motor according to claim 1,
wherein the gap length “L” and the thickness “t” are set in a range of L=0.6 to 0.7 [mm], t(t+L)=0.77 to 0.85.

3. The permanent magnet synchronous motor according to claim 1,
wherein, when the number of poles of the permanent magnets is “P”, the number of slots of the stator is “N”, the number of poles “P” and the number of slots “N” are set to be
P:N=5n:6n or 7n:6n (“n” is an integer of 2 or more).

4. The permanent magnet synchronous motor according to claim 3,
wherein the number of poles of the permanent magnets is set to 10, and the number of slots of the stator is set to 12.

5. The permanent magnet synchronous motor according to claim 1,
wherein the stator core has a configuration in which laminated steel sheets overlap one another at contact portions of split cores as well as are coupled by circular projections provided at overlapped portions to rotate one another.

6. The permanent magnet synchronous motor according to claim 5,
wherein rotation lamination is performed to the stator core.

7. The permanent magnet synchronous motor according to claim 1,
wherein the stator core is configured by a coupled core in which plural core portions are coupled in a belt shape.

8. The permanent magnet synchronous motor according to claim 1,
wherein the permanent magnet is an NdFe rare-earth segment permanent magnet, and when a thickness of the central portion of the permanent magnet in the rotation direction is “t” [mm] and a thickness of both end portions of the permanent magnet is “e” [mm], the thickness of the central portion of the permanent magnet in the rotation direction “t” and the thickness of both end portions of the permanent magnet “e” is set in a range of
0.4≦e/t≦0.7.

9. The permanent magnet synchronous motor according to claim 1,
wherein the permanent magnet is an NdFe rare-earth segment permanent magnet and remanent flux density Br is set in a range of
Br≧1.2 [T]

10. The permanent magnet synchronous motor according to claim 1,
wherein the motor is for an electric power steering system.
